(19) United States
(12) Patent Application Publication
(10) Pub. No.: US 2016/0347209 A1
(43) Pub. Date: Dec. 1, 2016

(54) VEHICLE SEAT, IN PARTICULAR MOTOR VEHICLE SEAT

(71) Applicant: JOHNSON CONTROLS COMPONENTS GMBH & CO. KG, Kaiserslautern (DE)

(72) Inventors: Wolfgang PLUTA, Heiligenmoschel (DE); Christian WOLF, Katzenbach (DE); Thomas DILL, Heiligenmoschel (DE); Thomas CHRISTOFFEL, Herschweiler-Pettersheim (DE)

(21) Appl. No.: 15/117,283

(22) PCT Filed: Jan. 29, 2015
(86) PCT No.: PCT/EP2015/051821

§ 371 Date: Aug. 8, 2016

(30) Foreign Application Priority Data
Feb. 7, 2014 (DE) 10 2014 202 315.7
Apr. 4, 2014 (DE) 10 2014 206 537.2

(51) Int. Cl. B60N 2/12; F16C 1/22; B60N 2/08

(52) U.S. Cl. CPC B60N 2/12; B60N 2/0881; F16C 1/22; F16C 2326/08

(57) ABSTRACT

A vehicle seat (1) has a seat part (3), a backrest (5), pivotable about a pivot axis (S) with respect to the seat part (3), a pair of seat rails (11, 13) for longitudinally adjusting the vehicle seat (1), and a seat rail locking device (17) for locking the at least one pair of seat rails (11, 13). The backrest (5) can take up a use position (5.1) suitable for transporting a person, and an easy-entry position (5.2) in which the backrest (5) has been pivoted forward about the pivot axis (S) and the seat rail locking device (17) has been opened via a Bowden cable unit (80). To pivot the backrest (5) back out of the easy-entry position (5.2) in the direction of the use position (5.1), a limit force has to be overcome that is generated by a compensation spring unit (85) of the Bowden cable unit (80).

### CROSS REFERENCE TO RELATED APPLICATIONS

This application is a United States National Phase Application of International Application PCT/EP2015/051821 filed Jan. 29, 2015 and claims the benefit of priority under 35 U.S.C. §119 of German Applications 10 2014 202 315.7 filed Feb. 7, 2014 and 10 2014 206 537.2 filed Apr. 4, 2014, the entire contents of which are incorporated herein by reference.

### FIELD OF THE INVENTION

The invention relates to a vehicle seat, in particular a motor vehicle seat, having a seat part, a backrest that is pivotable about a pivot axis with respect to the seat part, at least one pair of seat rails for longitudinally adjusting the vehicle seat, and a seat rail locking device for locking the at least one pair of seat rails, wherein the backrest can take up a use position suitable for transporting a person, and an easy-entry position in which the backrest has been pivoted forward about the pivot axis and the seat rail locking device has been opened via a Bowden cable unit, and wherein, in order to pivot the backrest back out of the easy-entry position in the direction of the use position, a limit force has to be overcome.

### BACKGROUND OF THE INVENTION

Vehicle seats having a seat part and a backrest which are displaceable relative to the vehicle structure on seat rails are known by use. The backrest is pivotable relative to the seat part and can take up an easy-entry position in order to make it easier to access a further vehicle seat row arranged behind the vehicle seat. To this end, the backrest of the vehicle seat is pivoted at least partially forward and the seat rails are opened via a Bowden cable unit. The entire vehicle seat can subsequently be slid forward by pressing on the backrest. In addition to the easy-entry position, the backrest can take up a cargo floor position, in which the backrest is pivoted forward into as horizontal a position as possible. This backrest position would be unsuitable for achieving the easy-entry position, since the user of the vehicle seat can slide it forward best with the backrest only partially pivoted forward.

DE 102 06 303 A1 discloses a fitting for a two-door motor vehicle, which serves to make it easier to access the rear passenger compartment by the backrest being pivoted freely forward into an easy-entry position in combination with the vehicle seat being slid forward, and to make different inclined positions of the backrest available for use by an occupant. In order to prevent undesired pivoting back of the backrest, for example given excessive padding in the transition region between the backrest and the seat part, a means for fixing the backrest in the freely pivoted position by means of a catch is provided. The catch can be opened again by the free-pivoting operating element, for example when the vehicle seat has been slid back into the seat longitudinal position previously taken up.

DE 10 2009 037 819 A1 discloses a vehicle seat having a setting fitting for setting the inclination of a backrest of the vehicle seat relative to a seat part of the vehicle seat, which comprises a free-pivoting unit for freely pivoting the backrest centrally from at least one use position into a freely pivoted position, i.e. an easy-entry position. The fitting also has a fitting lower part which is connected to the seat part and which carries the setting fitting, and a fitting upper part assigned to the free-pivoting unit, said fitting upper part being connected to the backrest. In the use position, the free-pivoting unit is locked in a form-fitting manner by means of a catch. In the easy-entry position, the back rest is secured in a force-fitting manner by means of said catch in that the catch fixes the fitting upper part by cooperating with a stop on the fitting lower part and in the process is secured in a force-fitting manner by means of a spring which is fastened to the fitting lower part, and acts on the catch in the easy-entry position of the backrest. In the easy-entry position of the backrest, the catch cooperates with the stop outside the self-locking region such that, by pulling on the backrest upper edge, an opening moment arises on the catch. Starting from a defined limit force, the securing force of the spring on the catch is overcome as a result, and the catch releases the fitting upper part for it to pivot back into the use position.

A Bowden cable unit having a first cable pull, a second cable pull and a compensation spring unit is described in DE 199 40 813 A1. Up to a limit force, the first cable pull is connected rigidly to the second cable pull via the compensation spring unit. When the limit force is exceeded, a spring in the compensation spring unit, said spring being connected in series with the first cable pull and the second cable pull, is compressed such that a distance between one end of the first cable pull and one end of the second cable pull is extended. The compensation spring unit serves for example as an overload protector.

Bowden cable units having a first cable pull, a second cable pull and a compensation spring unit, in which the first cable pull is rigidly connected to the second cable pull via the compensation spring unit up to a limit force, are by use. When the limit force is exceeded, a spring in the compensation spring unit, said spring being connected in series with the first cable pull and the second cable pull, is extended such that a distance between one end of the first cable pull and one end of the second cable pull is extended.

### SUMMARY OF THE INVENTION

The invention is based on the problem of improving a vehicle seat of the type mentioned at the beginning, in particular of providing the same kind of functionality with fewer components.

According to the invention, this problem is solved by a vehicle seat having a seat part, a backrest that is pivotable about a pivot axis with respect to the seat part, at least one pair of seat rails for longitudinally adjusting the vehicle seat, and a seat rail locking device for locking the at least one pair of seat rails, wherein the backrest can take up a use position suitable for transporting a person, and an easy-entry position in which the backrest has been pivoted forward about the pivot axis and the seat rail locking device has been opened via a Bowden cable unit, and wherein, in order to pivot the backrest back out of the easy-entry position in the direction of the use position, a limit force has to be overcome, wherein the limit force is generated by a compensation spring unit of the Bowden cable unit.

Since the spring force which keeps the backrest in the easy-entry position is generated by a compensation spring unit of the Bowden cable unit, the compensation spring unit assumes a further function and a separate spring can be dispensed with.

Preferably, the Bowden cable unit comprises a first cable pull, a second cable pull and the compensation spring unit. Up to a limit force, the first cable pull is rigidly connected to the second cable pull via the compensation spring unit. When the limit force is exceeded, the length of a spring of the compensation spring unit, said spring being connected to the first cable pull and the second cable pull, is changed. The compensation spring unit preferably has a spring which is arranged between the first cable pull and the second cable pull with regard to an operative connection. The first cable pull, the spring and the second cable pull can be connected in series.

Depending on the structure of the compensation spring unit, the spring in the compensation spring unit is extended or compressed when a limit force is exceeded. A distance between one end of the first cable pull and one end of the second cable pull can be extended when the spring is extended. This is the case for example when the spring is a helical tension spring and a first end of the helical tension spring is connected to the first cable pull and a second end of the helical tension spring is connected to the second cable pull.

Another, preferred compensation spring unit is disclosed in DE 199 40 813 A1. A spring in the compensation spring unit is compressed such that the distance between one end of the first cable pull and one end of the second cable pull is extended.

In the easy-entry position of the backrest, in a preferred embodiment, a first means can cooperate in particular in a force-fitting or form-fitting locking manner with a second means, wherein one of the means is assigned to the backrest and the other of the means is assigned to the seat part, and the means move relative to one another after the limit force has been overcome and while the backrest is being pivoted. A cable-pull end of the first cable pull of the Bowden cable unit is preferably fastened to one of the means, and a cable-pull end of the second cable pull is fastened to the seat rail locking device.

The backrest can be hinged to the seat part by means of two fittings that are known per se. The first and second means are preferably arranged on precisely one seat side and on a side of a fitting that faces toward the seat center.

The first means can be embodied as a rocker having a first arm and a second arm. The second means can be a slotted guide. One of the arms of the rocker can cooperate with the slotted guide. In particular, a contact means attached to one of the arms or a roller mounted on the one of the arms can cooperate with the slotted guide. In this case, contact takes place between the arm or the contact means or the roller and the slotted guide such that, in the event of a relative movement between the arm and the slotted guide, the slotted-guide contour causes the rocker to pivot. Such a rocker can be produced cost-effectively, for example as a punched metal part.

Preferably, the Bowden cable unit is fastened on one side to the other of the arms and on the other side to the seat rail locking device. A cable-pull end of the first cable pull of the Bowden cable unit can be fastened to the other of the arms, and a cable-pull end of the second cable pull can be fastened to the seat rail locking device.

The rocker is preferably fastened rotatably to the seat part, in particular to a fitting lower part of the seat part. The fitting lower part in this case connects a second fitting part of a fitting to the seat part. It is possible to dispense with a separate adapter between the seat part and rocker. However, an additional adapter for mounting the rocker can also be provided.

The slotted guide is advantageously connected firmly to the backrest. The slotted guide can in this case be integrated into a backrest structure or be configured as a separate part. By integrating the slotted guide into a backrest structure, it is possible to dispense with an additional component. A separately configured slotted guide which is connected to the backrest structure allows a modular backrest kit.

Preferably, the slotted guide has a first slotted guide portion which is assigned to the use position, and a second slotted guide portion which prevents the backrest from pivoting back out of the easy-entry position in the direction of the use position by cooperating with the rocker, as long as the limit force has not been overcome. In this case, the second slotted guide portion can project beyond the first slotted guide portion in the radial direction, preferably in the form of a cam. The first slotted guide portion is preferably curved about the pivot axis in the form of a circular arc.

Contact can take place between the arm or the contact means or the roller and the first slotted guide portion. Alternatively, however, the arm of the rocker can also bear against a supporting means such that no contact takes place in the first slotted guide portion and the arm, the contact means or the roller cooperates only with the second slotted guide portion and optionally with a third slotted guide portion.

By changing the lever ratio of the rocker, contours of the slotted guide and/or the characteristic line of the compensation spring unit, the movement sequence of the vehicle seat can be adapted optimally to the particular boundary conditions of the vehicle and customer requirements.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic illustration of a vehicle seat;

FIG. 2 is a side view from the outside of a region, surrounding a fitting, of the vehicle seat with a backrest in a use position;

FIG. 3 is a side view from the direction of the seat center of a region, surrounding the fitting, of the vehicle seat with a backrest in the use position;

FIG. 4 is a view corresponding to FIG. 3 shortly before the backrest reaches an easy package position (easy-entry position);

FIG. 5 is a view corresponding to FIG. 3 in the easy-entry position of the backrest;

FIG. 6 is a view corresponding to FIG. 2 in the easy-entry position of the backrest;

FIG. 7 is a schematic illustration of the vehicle seat in the easy-entry position of the backrest;

FIG. 8 is a detail view from FIG. 5 with consideration of forces; and

FIG. 9 is a detail view from FIG. 8 of a contact region between a rocker and a cam of a slotted guide.

### DESCRIPTION OF THE PREFERRED EMBODIMENTS

Referring to the drawings, a vehicle seat 1 is described in the following text in a Cartesian coordinate system which is defined by three spatial directions that are perpendicular to one another. A longitudinal direction x extends, in the case of a vehicle seat 1 installed in the vehicle, largely horizontally and preferably parallel to a vehicle longitudinal direction, which corresponds to the usual direction of travel of the vehicle. A transverse direction extending perpendicularly to the longitudinal direction x is likewise oriented horizontally in the vehicle and extends parallel to a vehicle transverse direction. A vertical direction z extends perpendicularly to the longitudinal direction x and perpendicularly to the transverse direction. In the case of a vehicle seat 1 installed in the vehicle, the vertical direction z extends parallel to the vehicle vertical axis.

The position and direction specifications used, for example front, rear, top and bottom, relate to a viewing direction of an occupant of the vehicle seat 1 in a normal sitting position, wherein the vehicle seat 1 is oriented as usual in the direction of travel. However, the vehicle seat 1 according to the invention can also be installed in some other orientation, for example transversely to the direction of travel.

The vehicle seat 1 has a seat part 3 and a backrest 5 which is pivotable relative to the seat part 3 about a pivot axis S that extends in the transverse direction and is defined by two fittings 7. The two fittings 7 are in this case operatively connected together via a transmission rod 9 that in the present case is likewise oriented in the transverse direction and is arranged concentrically with the pivot axis S, such that unlocking of one of the two fittings 7 inevitably brings about unlocking of the other fitting 7.

Each of the two fittings 7 comprises a first fitting part 7.1 and a second fitting part 7.2 that is rotatable, with the fitting 7 unlocked, relative thereto about the pivot axis S. From a structural point of view, the two fitting parts 7.1 and 7.2 (and a clasping ring) together form a disk-like unit. With the mounting of the fitting 7, the first fitting part 7.1 is firmly connected by means of a fitting upper part 7.3 to the structure of the backrest 5, i.e. is secured to the backrest. The second fitting part 7.2 is firmly connected by means of a fitting lower part 7.4 to the structure of the seat part 3, i.e. is secured to the seat part. The two fittings 7 are configured as a latching fitting, as is known for example from DE 10 2009 041 492 A1.

The vehicle seat 1 is attached to a vehicle structure of the vehicle, so as to be longitudinally displaceable in the longitudinal direction x, by means of two pairs of seat rails that are oriented in the longitudinal direction x and are known per se. The two pairs of seat rails comprise two first rails 11 that are movable relative to the vehicle structure and are arranged parallel to one another and two associated second rails 13 that are secured to the vehicle structure and engage around and guide the first rails 11. By means of in each case one seat rail locking device 17 that is known per se, the respective first rails 11 can be locked to the respective second rails 13. With the seat rail locking devices 17 unlocked, the first rails 11 can be moved relative to the second rails 13 and thus the position of the vehicle seat 1 can be changed relative to the vehicle structure in the longitudinal direction x. In a modification of the exemplary embodiment, the vehicle seat 1 has only exactly one seat rail locking device 17, specifically acting between one of the two pairs of seat rails.

The backrest 5 of the vehicle seat 1 can be moved from a use position 5.1 (illustrated in FIG. 1) which is inclined toward the rear with respect to the vertical direction z and is suitable for transporting a person, both into a cargo floor position 5.3, in which the backrest 5 has been pivoted forward about the pivot axis S onto the seat part 3, and into an easy-entry position 5.2. In the easy-entry position 5.2, the backrest 5 has been pivoted forward about the pivot axis S into a forwardly pivoted position with respect to the vertical direction z, but not as far as the cargo floor position 5.3. In addition, when the easy-entry position 5.2 is reached, the seat rail locking device 17 is unlocked and the vehicle seat 1 can be slid forward. As a result, an entry and exit region that is as large as possible for a seat, arranged behind the vehicle seat 1 and not illustrated in the Figures, of a rear, in particular third, seat row can be made available.

In the cargo floor position 5.3, the backrest 5 has been pivoted even further forward with respect to the easy-entry position 5.2 and preferably rests on the seat part 3.

For unlocking of the seat rail locking devices 17 that is independent of the easy-entry position 5.2 of the back rest 5, and thus for settability of the vehicle seat 1 in the longitudinal direction x, a pivotable bar 15 that is arranged beneath the seat part 3 in the front region of the vehicle seat 1 is provided, the ends of said bar 15 being operatively connected to the seat rail locking devices 17 in a manner known per se. The bar 15 allows the pairs of seat rail 11, 13 to be unlocked manually by the bar 15 being pulled up. The vehicle seat 1 can be slid in the longitudinal direction x within a predetermined range, as long as the bar 15 is pulled up and as a result the seat rail locking devices 17 are kept disengaged. The bar 15 can in this case be attached to a reinforcing transmission bar which is rotated when the bar 15 is pulled up. This transmission bar can be mounted on the respective first rail 11 on both sides of the seat and couples the locked state of the two seat rail locking devices 17 of the two pairs of seat rails 11, 13 together.

An operating element 20 is operatively connected to the transmission rod 9 on a seat outer side, such that actuating of the operating element 20 rotates the transmission rod 9, either directly upon actuation or only after a small free travel has been passed through. As a result, the two fittings 7 are opened and the backrest 5 is pivotable relative to the seat part 3 about the pivot axis S. A first spring 22 biases the operating element 20 counter to an actuating direction in the direction of a starting position in which the two fittings 7 are locked.

In the upper region of the backrest 5, a second operating element (not illustrated in FIG. 1) for unlocking the fittings 7, in particular for pivoting the backrest 5 forward into the easy entry position 5.2, can additionally be provided, said second operating element being at least indirectly coupled to the operating element 20.

In the present case, a comfort setting of the backrest 5 is also possible, which allows precision setting of a backrest inclination angle about the pivot axis S in a small comfort angular range (for example up to 10° rearward and up to 2° forward) around the use position 5.1. The comfort setting of the backrest 5 can also be dispensed with, however.

On at least one seat outer side, a catch 30 is mounted on the fitting lower part 7.4 so as to be rotatable about a catch rotation axis 40. The catch rotation axis 40 is arranged eccentrically with respect to the pivot axis S of the backrest 5, in the present case in a region, located behind and above the pivot axis S, of the fitting lower part 7.4. The catch rotation axis 40 is in the present case identical to the central axis of a first bearing bolt 40 which is riveted to the fitting lower part 7.4 in a manner known per se or is screwed into the latter.

The catch 30 is arranged in the transverse direction between the fitting lower part 7.4 and the operating element 20.

The catch 30 is V-shaped, with a first leg 31 and a second leg 32 which enclose an angle of about 50° between one another. The invention is not limited to this angle, however.

In the region in which the first leg 31 and the second leg 32 converge, an opening for receiving the first bearing bolt 40 and thus for rotatably mounting the catch 30 is provided.

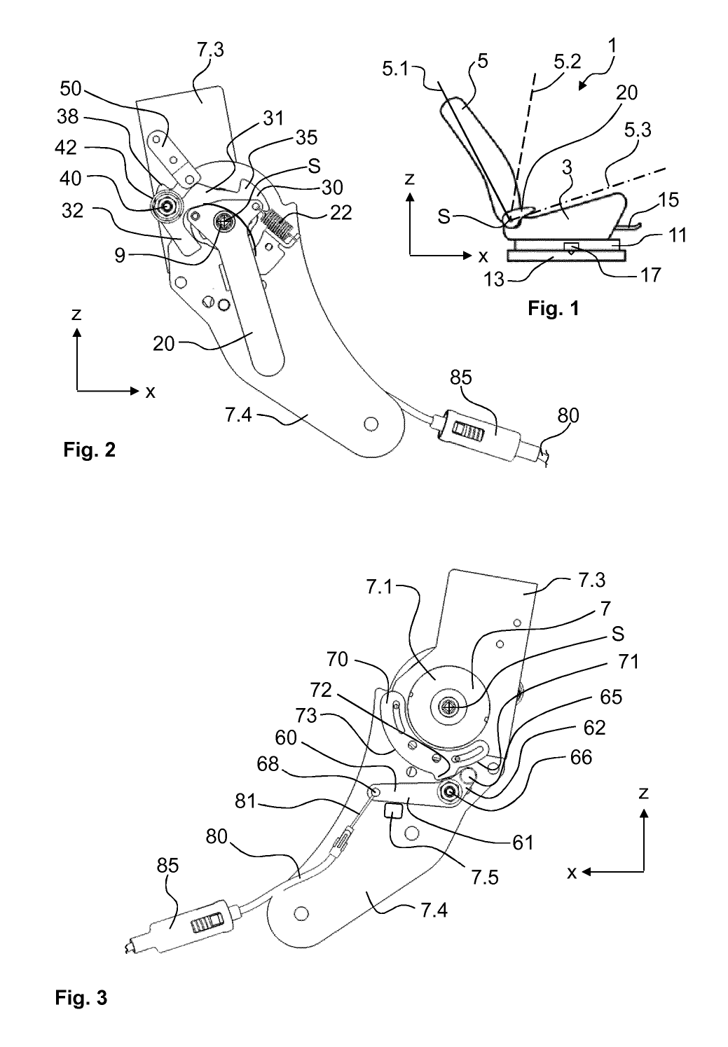

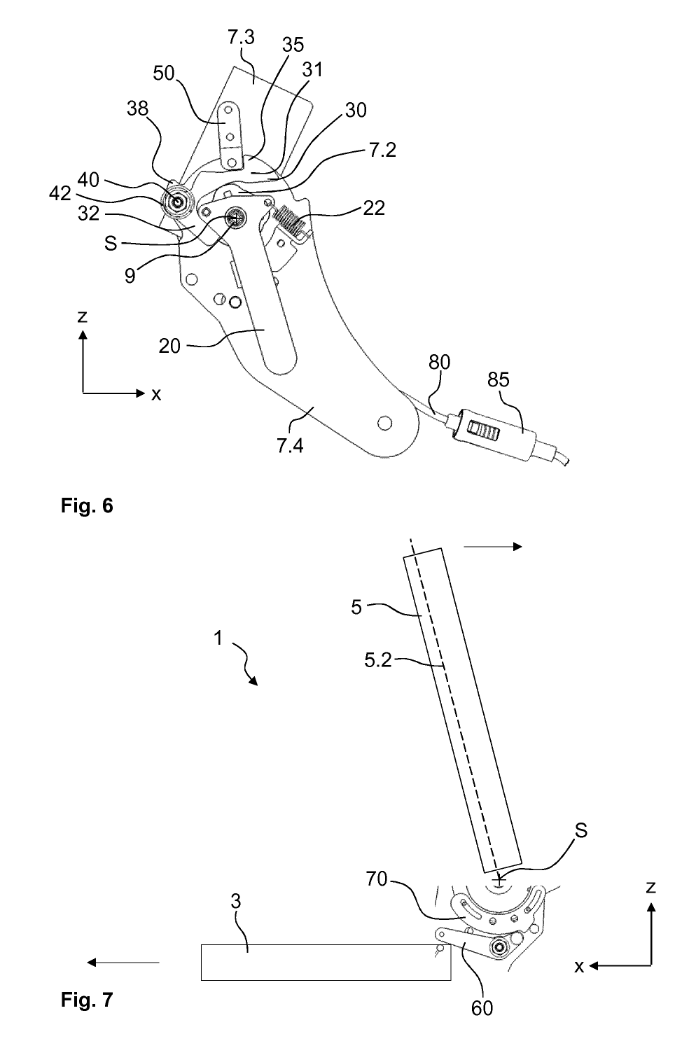

A second spring 42 biases the catch 30 against a stop 50 fastened to the fitting upper part 7.3, in the counterclockwise direction in FIGS. 2 and 6. The stop 50 is configured in the present case as a sheet-metal angle which engages over the outside of the fitting lower part 7.4.

The first leg 31 of the catch 30 has, on its side oriented away from the second leg 32, a basic contour that is curved around the pivot axis S and has such a notch in a direction oriented toward the catch pivot axis 40 that a detent 35 is formed. The detent 35 serves to cooperate with the stop 50 in the easy-entry position 5.2 of the backrest 5. In the direction of the catch rotation axis 40, the curved outer basic contour of the first leg 31 is delimited by a radially outwardly protruding counterstop 38 against which the stop 50 bears in the rearmost position of the backrest 5. The rearmost position of the backrest 5 corresponds to the use position 5.1 in an embodiment of the fitting 7 without a comfort angular range.

On that side of the fitting lower part 7.4 that is oriented toward the seat center, as seen in the transverse direction, a rocker 60 is mounted on the fitting lower part 7.4 in a rotatable manner on a rocker rotation axis 66. The rocker rotation axis 66 is arranged eccentrically with respect to the pivot axis S of the backrest 5, in the present case in a region, located beneath the pivot axis S, of the fitting lower part 7.4. The rocker rotation axis 66 is in the present case identical to the central axis of a second bearing bolt 66, which is riveted to the fitting lower part 7.4 in a manner known per se or is screwed into the latter.

The rocker 60 is V-shaped with a first arm 61 and a second arm 62 which enclose an angle of about 135° between one another. The invention is not limited to this angle, however.

In the region in which the first arm 61 and the second arm 62 converge, an opening for receiving the second bearing bolt 66 and thus for rotatably mounting the rocker 60 is provided.

The first arm 61 has, at its end remote from the rocker rotation axis 66, a Bowden cable fastening means 68, in the present case a hole for hooking in a first cable pull 81 of the Bowden cable unit 80. The second arm 62 has, at its end remote from the rocker rotation axis 66, a roller 65 that is mounted rotatably on the second arm 62 and serves, in conjunction with a slotted guide 70 fastened to the fitting upper part 7.3, as a contact means. The contact means does not have to be configured as a roller 65, but could for example be also be a cam formed out of the second arm 62.

The slotted guide 70 has a basic shape in the form of a ring segment which extends in a curved manner about the pivot axis S. The slotted guide 70 is in the present case a pressed sheet-metal part that is fastened, in particular welded, to the fitting upper part 7.3, but, in a modification of the exemplary embodiment, can also be produced in one piece from the fitting upper part 7.3.

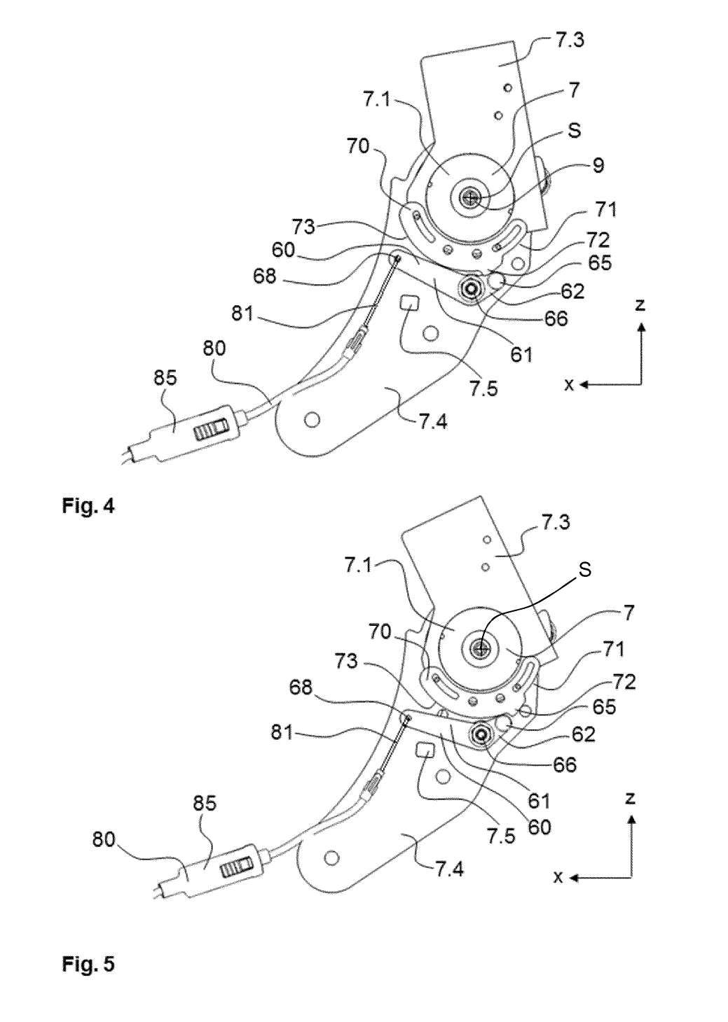

The slotted guide 70 comprises a radially outwardly directed outer contour that serves as a control contour and cooperates with the roller 65 of the rocker 60. A first slotted-guide portion 71 is located opposite the roller 65 in the use position 5.1 of the backrest 5. A second slotted-guide portion that protrudes radially outwardly from the first slotted-guide portion 71 is configured as a cam 72 and comes into contact with the roller 65 when the backrest 5 is transferred from the use position 5.1 into the easy-entry position 5.2, and pushes said roller 65 in the radial direction away from the pivot axis S. As a result, the rocker 60 is rotated (in the clockwise direction in FIGS. 3 and 4). The cam contour of the cam 72 is curved in a slightly spiral-shaped manner about the pivot axis S, such that the distance between the cam 72 and the pivot axis S increases in a direction away from the first slotted-guide portion 71. The cam 72 adjoins the first slotted-guide portion 71 in the circumferential direction.

A third slotted-guide portion 73 is arranged in the circumferential direction on that side of the cam 72 that is remote from the first slotted-guide portion 71. The third slotted-guide portion 73 is located further inward in the radial direction with respect to the cam contour of the cam 72 and further outward in the radial direction with respect to the first slotted-guide portion 71. The third slotted-guide portion 73 is located opposite the roller 65 when the backrest 5 is transferred from the easy-entry position 5.2 into the cargo floor position 5.3.

Optionally, a support 7.5 can be provided, which is stamped out of the fitting lower part 7.4 in the present case in the direction of the rocker 60 and bears against an outer contour, directed away from the second arm 62, of the first arm 61 in the use position 5.1 of the backrest 5. This avoids a situation in which the roller 65 bears against the slotted guide 70 in the use position 5.1 and optionally in the comfort positions of the backrest 5.

The Bowden cable unit 80 connects the rocker 60 directly or indirectly to the two seat rail locking devices 17, such that pivoting of the rocker 60 (in the clockwise direction in FIGS. 3, 4, 5, 7, 8 and 9) causes the seat rail locking devices 70 to open.

The Bowden cable unit 80 comprises the first cable pull 81 and a second cable pull (not illustrated in the Figures). The first cable pull 81 is fastened, in particular hooked in, at the cable pull fastening 68 of the rocker 60. The second cable pull is connected directly or indirectly to the two seat rail locking devices 17.

The first cable pull 81 and the second cable pull are connected together by means of a compensation spring unit 85. The compensation spring unit 85 connects the first cable pull 81 and the second cable pull rigidly together up to a limit force. When the limit force is exceeded, a spring in the compensation spring unit 85, said spring being connected in series with the first cable pull 81 and the second cable pull, is extended such that the distance between one end of the first cable pull 81 and one end of the second cable pull is also extended. In a modification of the exemplary embodiment, the first cable pull 81 and the second cable pull are connected in series with the spring such that the spring is compressed when the limit force is exceeded and as a result the distance between one end of the first cable pull 81 and one end of the second cable pull is extended, as described in DE 199 40 813 A1.

FIGS. 2 and 3 show a part of the vehicle seat 1 in the use position 5.1 of the backrest 5. The catch 30 is held in a starting angular position by the stop 50. The rocker 60 bears against the support means 7.5 such that there is a small clearance between the roller 65 and the first slotted-guide portion 71.

In FIG. 4, the fitting 7 is in an unlocked state (by actuation of the operating lever 20 not illustrated in FIG. 4) and the backrest 5 has been flapped forward in the direction of the easy-entry position 5.2, but without having reached the easy-entry position 5.2. As soon as the roller 65 comes into contact with the cam 72 of the slotted guide 70, the rocker 60 is deflected about the rocker rotation axis 66. As a result, the seat rail locking devices 17 are unlocked by means of the Bowden cable unit 80. Upon further pivoting of the backrest 5 in the direction of the easy-entry position 5.2, the rocker 60 is deflected further on account of the cam contour of the cam 72 that is curved in a spiral-shaped manner about the pivot axis S. The additional travel is then absorbed by the compensation spring unit 85, since the seat rail locking devices 17 are already in a fully open state and at an end stop.

The necessary force for unlocking the seat rail locking devices 17 is less than the limit force of the compensation spring unit 85. This ensures that the seat rail locking devices 17 unlock before the compensation spring unit 85 becomes effective and causes extension of the Bowden cable unit 80.

FIGS. 5 and 6 show a part of the vehicle seat 1 in the easy-entry position 5.2 of the backrest 5, that is to say after the easy-entry position 5.2 has been reached. The roller 65 now bears against the cam 72, directly behind the cam 72, as seen in the circumferential direction. The second spring 42 has rotated the catch 30 such that the stop 50 bears against the detent 35 and so the backrest 5 cannot be pivoted forward further in the direction of the cargo floor position 5.3. The compensation spring unit 85 is relaxed. In a modification of the exemplary embodiment, the compensation spring unit 85 remains slightly pretensioned in this region (roller 65 bears against the second slotted-guide portion 72). The seat rail locking devices 17 are unlocked. The vehicle seat 1 can be slid forward into an easy-entry position from a starting position by means of the rails 11, 13 in order to increase the entry space to a rear seat row.

The cam 72 bearing against the roller 65 outside a self-locking region prevents the backrest 5 from pivoting back in the direction of the use position 5.1. In order to pivot the backrest 5 back, a return pivoting force F3 has to be applied to the upper region of the backrest 5, and this force has to be at least large enough for the limit force of the compensation spring unit 85 to be overcome, such that the spring in the compensation spring unit 85 is extended. The compensation spring unit 85 thus generates, in cooperation with the cam 72, a limit torque forward about the pivot axis S, and this has to be overcome in order to be able to pivot the backrest 5 back into the use position 5.1 again.

The return pivoting force F3 can be adjusted as desired by changing the contour of the cam 72. The return pivoting force F3 can also be influenced by changing the lever transmission and the lever ratios of the rocker 60 and catch 30.

In order to pivot the backrest 5 further from the easy-entry position 5.2 in the direction of the cargo floor position 5.3, the operating element 20 has to be actuated again (in the counterclockwise direction in FIGS. 2 and 6). In the process, the operating element 20 comes into contact with the second leg 32 of the catch 30 and pivots the catch 30 (in the clockwise direction in FIGS. 2 and 6) such that the stop 50 can pivot past the detent 35 of the catch 30. The seat rail locking devices 17 remain open even in the cargo floor position 5.3 on account of the contact between the roller 65 and the third slotted-guide portion 73. However, the contour of the third slotted-guide portion 73 can also be modified such that, in the cargo floor position 5.3 of the backrest 5, the seat rail locking devices 17 unlock again (engagement function in the cargo floor position 5.3). In a modification of the exemplary embodiment, slight pretensioning by the compensation spring unit 85 brings about a force by the roller 65 on the third slotted-guide portion 73. This force serves as damping during the pivoting operation of the backrest 5.

When the vehicle seat 1 is slid back from the front easy-entry position into the starting position, a rail displacement force that is necessary therefor is less than a force component, oriented in the longitudinal direction x, of the return pivoting force F3 to be applied to the backrest 5 by a user of the vehicle seat 1. This ensures that the vehicle seat 1 is first of all displaced back into the starting position in the longitudinal direction x and thus to an end stop before the roller 65 can overcome the cam 72 and as a result the backrest 5 can be pivoted back into the use position 5.1.

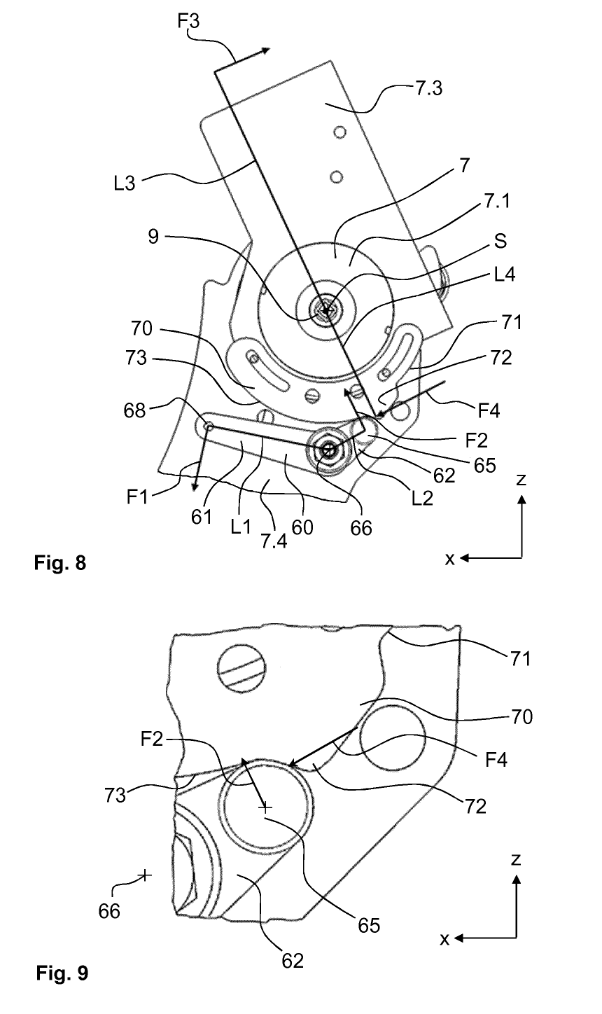

In FIGS. 8 and 9, the force ratios on the vehicle seat 1 immediately before the backrest 5 is pivoted back from the easy-entry position 5.2 into the use position 5.1 are illustrated schematically and in a simplified manner.

The compensation spring unit 85 generates a first force F1 in the point of the Bowden cable fastening 68 at a first distance L1 from the rocker rotation axis 66. The first force F1 is approximately perpendicular to a connecting line between the pivot axis S and the Bowden cable fastening 68. On account of the different lengths of the first arm 61 and second arm 62 and the lever ratios resulting therefrom, the second arm 62 pushes the roller 65, arranged at a second distance L2 from the pivot axis S, with a second force F2 in an approximately radial direction against the third slotted-guide portion 73. In this case, the following pertains: F2=F1*L1/L2. The contact point between the roller 65 and the slotted guide 70 travels, with increasing F2, from the third slotted-guide portion 73 to the cam 72, such that L2 and thus F2 continuously change.

The return pivoting force F3, as a third force, is initiated by the user in the upper region of the backrest 5. A third distance L3 is defined as the distance between the pivot axis S and the point of attack of the return pivoting force F3. A fourth distance L4 is defined as the distance between the pivot axis S and the contact point between the roller 65 and the cam 72.

On account of the present lever ratios about the pivot axis S, the return pivoting force F3 generates a fourth force F4 at the contact point between the roller 65 and the cam 72, which is located at the fourth distance L4 from the pivot axis S. The following pertains: F4=F3*L3/L4.

The fourth force F4 brings about, via the cam 72, a torque on the rocker 60 about the rocker rotation axis 66, said torque counteracting a torque, generated by the first force F1, on the rocker 60. In order that the roller 65 can travel over the cam 72, a force component, acting counter to the second force F2, of the fourth force F4 can generate a greater torque about the rocker rotation axis 66 than the second force F2. This force component of the fourth force F4 is dependent on the contour of the cam. The steeper the contour becomes, the smaller the force component, acting in the opposite direction to F2, of the fourth force F4 also becomes.

The features disclosed in the above description, the claims and the drawings can be important both individually and in combination in order to realize the invention in its various configurations.

While specific embodiments of the invention have been shown and described in detail to illustrate the application of the principles of the invention, it will be understood that the invention may be embodied otherwise without departing from such principles.

1. A motor vehicle seat comprising:
a seat part;
a backrest that is pivotable about a pivot axis with respect to the seat part;
at least one pair of seat rails for longitudinally adjusting the vehicle seat;
a Bowden cable unit;
a seat rail locking device for locking the at least one pair of seat rails, wherein the backrest can take up a use position suitable for transporting a person, and an easy-entry position in which the backrest has been pivoted forward about the pivot axis and the seat rail locking device has been opened via the Bowden cable unit; and
a compensation spring unit associated with the Bowden cable unit, wherein, in order to pivot the backrest back out of the easy-entry position in the direction of the use position, a limit force has to be overcome and the limit force is generated by the compensation spring unit of the Bowden cable unit.

2. The vehicle seat as claimed in claim 1, wherein, in the easy-entry position, a first means cooperates in a locking manner with a second means, wherein one of the means is assigned to the backrest and the other of the means is assigned to the seat part, and the means move relative to one another after the limit force has been overcome and while the backrest is being pivoted.

3. The vehicle seat as claimed in claim 2, wherein the first means is embodied as a rocker having a first arm and a second arm, the second means is a slotted guide, and one of the arms cooperates with the slotted guide.

4. The vehicle seat as claimed in claim 3, wherein a contact element is attached to one of the arms and cooperates with the slotted guide.

5. The vehicle seat as claimed in claim 3, wherein a roller is mounted on one of the arms and cooperates with the slotted guide.

6. The vehicle seat as claimed in claim 3, wherein the Bowden cable unit is fastened on one side to the other of the arms and on the other side to the seat rail locking device.

7. The vehicle seat as claimed in claim 3, wherein the rocker is fastened rotatably to a fitting lower part of the seat part.

8. The vehicle seat as claimed in claim 3, wherein the slotted guide is connected firmly to the backrest.

9. The vehicle seat as claimed in claim 3, wherein the slotted guide has a first slotted guide portion which is assigned to the use position, and a second slotted guide portion which prevents the backrest from pivoting back out of the easy-entry position in the direction of the use position by cooperating with the rocker, as long as the limit force has not been overcome.

10. The vehicle seat as claimed in claim 9, wherein the second slotted guide portion projects beyond the first slotted guide portion in the radial direction.

11. The vehicle seat as claimed in claim 9, wherein the first slotted guide portion extends in the form of a circular arc about the pivot axis.

12. The vehicle seat as claimed in claim 1, wherein the Bowden cable unit comprises the compensation spring unit, a first cable pull and a second cable pull, wherein the compensation spring unit has a spring which is arranged between the first cable pull and the second cable pull with regard to an operative connection.

13. The vehicle seat as claimed in claim 12, wherein the first cable pull, the spring and the second cable pull are connected in series.

14. The vehicle seat as claimed in claim 12, wherein the spring in the compensation spring unit is extended when the limit force is exceeded, such that a distance between one end of the first cable pull and one end of the second cable pull is extended.

15. The vehicle seat as claimed in claim 12, wherein the spring in the compensation spring unit is compressed when the limit force is exceeded, such that a distance between one end of the first cable pull and one end of the second cable pull is extended.
